(19) United States
(12) Patent Application Publication
(10) Pub. No.: US 2015/0163827 A1
(43) Pub. Date: Jun. 11, 2015

(54) Apparatus and Method for Paging for Mutli-Standby Devices

(71) Applicant: Broadcom Corporation, Irvine, CA (US)

(72) Inventor: Ozgur EKICI, San Diego, CA (US)

(73) Assignee: Broadcom Corporation, Irvine, CA (US)

(21) Appl. No.: 14/158,523

(22) Filed: Jan. 17, 2014

Related U.S. Application Data
(60) Provisional application No. 61/912,994, filed on Dec. 6, 2013.

(51) Int. Cl. H04W 74/08; H04W 68/02

(52) U.S. Cl. CPC H04W 74/0825; H04W 68/02

(57) ABSTRACT

An apparatus and methods for improving paging performance for multi-standby devices having multiple subscriber identity module (SIM) cards are disclosed. For example, one method includes determining, by a user equipment (UE), a paging collision between a first paging channel associated with a first subscriber identity module (SIM) card and a second paging channel associated with a second SIM card. The method further includes monitoring the second paging channel and monitoring a physical channel associated with the first SIM card and different than the first paging channel.

### CROSS REFERENCE TO RELATED APPLICATIONS

The present application claims priority to U.S. Provisional Patent Application No. 61/912,994, filed on Dec. 6, 2013, which is hereby incorporated by reference in its entirety.

### BACKGROUND

1. Field

The present disclosure relates generally to apparatus and methods for improving paging performance for multi-standby devices having multiple subscriber identity module (SIM) cards.

2. Background Art

With the development of mobile communication systems, a user equipment (UE) may utilize various mobile communication techniques such as, for example, global system for mobile communications (GSM), Universal Mobile Telecommunications System (UMTS), Long Term Evolution (LTE) network, and wireless local area network (WLAN) to receive desired services. When the UE subscribes to a communication network, subscriber information may be required to identify the UE to the network for various network services such as authentication, accounting, billing, security services, etc. The subscriber information may be stored in a subscriber identity module (SIM) card inserted in the UE. A SIM card is a card or a chip installed in the UE providing information to identify the subscriber carrying the mobile device to networks.

A multi-standby device includes multiple SIM cards for connections to two or more independent network operators and/or wireless technologies. It is known that the probability of missing a mobile terminated call is higher for multi-standby devices (e.g., dual-SIM, triple-SIM, etc.) in comparison to regular (i.e. single SIM) devices. This is because multi-standby devices, as per design, are required to monitor simultaneously two or more paging channels of two or more independent network operators and/or wireless technologies. Independent listening of multiple paging channels can cause page collisions (e.g., page messages from different networks happen to occur at the same time instant) which drastically increases the probability of missed pages (e.g., around 9% page miss probability with dual-SIM devices; whereas it is 0% for single SIM devices). At the same time, simultaneous monitoring of two or more paging channels also has battery impact on the multi-SIM mobile devices.

### BRIEF DESCRIPTION OF THE DRAWINGS/FIGURES

The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1 illustrates a system, in accordance with an embodiment of the present disclosure.

FIG. 2 illustrates a paging collision, in accordance with a conventional method.

FIG. 3 illustrates a device, in accordance with an embodiment of the present disclosure.

FIGS. 4A and 4B illustrate timing relation between two physical channels of a 3G/UMTS system.

FIG. 5 is a flowchart illustrating a method, in accordance with an embodiment of the present disclosure.

FIG. 6 is a flowchart illustrating a method, in accordance with another embodiment of the present disclosure.

FIG. 7 illustrates a timing diagram, in accordance with a conventional method.

FIG. 8 illustrates a timing diagram, in accordance with an embodiment of the present disclosure.

FIG. 9 is a flowchart illustrating a method, in accordance with another embodiment of the present disclosure.

FIG. 10 is a flowchart illustrating a method, in accordance with another embodiment of the present disclosure.

FIGS. 11A and 11B are flowcharts illustrating methods, in accordance with another embodiment of the present disclosure.

FIG. 12 is a flowchart illustrating a method, in accordance with another embodiment of the present disclosure.

FIG. 13 illustrates a computer system that can be utilized to implement one or more embodiments of the present disclosure.

The present disclosure will now be described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

### Overview

Apparatus and methods are provided for improving paging performance for multi-standby devices having multiple subscriber identity module (SIM) cards. A first SIM is associated with a first network service having a first paging cycle, the first paging cycle having a paging indicator channel and a paging message channel. (e.g. UMTS/3G) A second SIM is associated with a second network service having a second paging cycle that includes only a paging message channel, without a paging indictor channel. (e.g. 2G) According to an embodiment of the disclosure, an apparatus and method are provided that include determining, by a user equipment (UE), a paging collision between the paging indicator channel associated with a first SIM and the paging message channel associated with a second SIM. Upon collision detection, the UE gives priority to monitoring the paging message channel associated with a second SIM of the second paging cycle, and then afterward determines whether any paging message can still be recovered for the first SIM during the first paging cycle.

According to another embodiment of the disclosure, an apparatus and method are provided that include collecting, by a UE, information regarding paging repetition of a first paging channel associated with a first SIM and information regarding paging repetition of a second paging channel associated with a second SIM. The apparatus and method further includes determining that the first paging channel has less paging repetition than the second paging channel, detecting, by the UE, a paging collision between the first paging channel and the second paging channel, and monitoring the first paging channel in response to the detected paging collision.

According to another embodiment of the disclosure, an apparatus and method are provided that include detecting, by a UE, data inactivity and transmitting a radio link release request to a base station associated with a network operator, wherein the radio link release request includes a message requesting for a paging cycle that is lower than a default paging cycle that is normally assigned by the network operator. The apparatus and method further include receiving a connection release message confirming the longer paging cycle.

According to another embodiment of the disclosure, an apparatus and method are provided that include determining, by a user equipment (UE), that a first paging monitoring cycle associated with a first SIM and a second paging monitoring cycle associated with a second SIM card are the same. The apparatus and method further include determining that the first and second paging monitoring cycles collide and designating every other instance of the first and second paging monitoring cycles to the first SIM. The apparatus and method further include designating other instances of the first and second paging monitoring cycles to the second SIM card.

According to another embodiment of the disclosure, an apparatus and method are provided that include determining, by a UE, that a first paging monitoring cycle associated with a first SIM, which is associated with a first radio access technology (RAT), and a second paging monitoring cycle associated with a second SIM card are the same. The apparatus and method further determining that the first and second paging monitoring cycles collide and determining that the first SIM is associated with a second RAT, where the second RAT has a third paging monitoring cycle. The apparatus and method further include changing from the first RAT to the second RAT for monitoring a paging channel associated with the first SIM.

According to another embodiment of the disclosure, an apparatus and method are provided that include detecting, by a UE, that Circuit Switch (CS) domain and Packet Switch (PS) domain of a network provider have different paging monitoring cycles. The apparatus and method further determining that a paging monitoring cycle of the PS domain is more frequent than a paging monitoring cycle of the CS domain and requesting, from the network provider, to increase a period of the paging monitoring cycle of the PS domain.

### Detailed Discussion

The following Detailed Description of the present disclosure refers to the accompanying drawings that illustrate exemplary embodiments consistent with this disclosure. The exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein. Therefore, the detailed description is not meant to limit the present disclosure.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

For purposes of this discussion, the term “module” and the like, shall be understood to include at least one of software, firmware, and hardware (such as one or more circuits, microchips, processors, or devices, or any combination thereof), and any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

Terms like “user equipment,” “mobile station,” “mobile,” “mobile device,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms may be utilized interchangeably in the subject specification and related drawings. Likewise, the terms “access point,” “base station,” “base transceiver station”, “Node B.” “evolved Node B (eNode B),” home Node B (HNB),” “home access point (HAP),” or the like, may be utilized interchangeably in the subject specification and drawings, and refer to a wireless network component or apparatus that serves and receives data, control, voice, video, sound, gaining, or substantially any data-stream or signaling-stream from a set of subscriber stations.

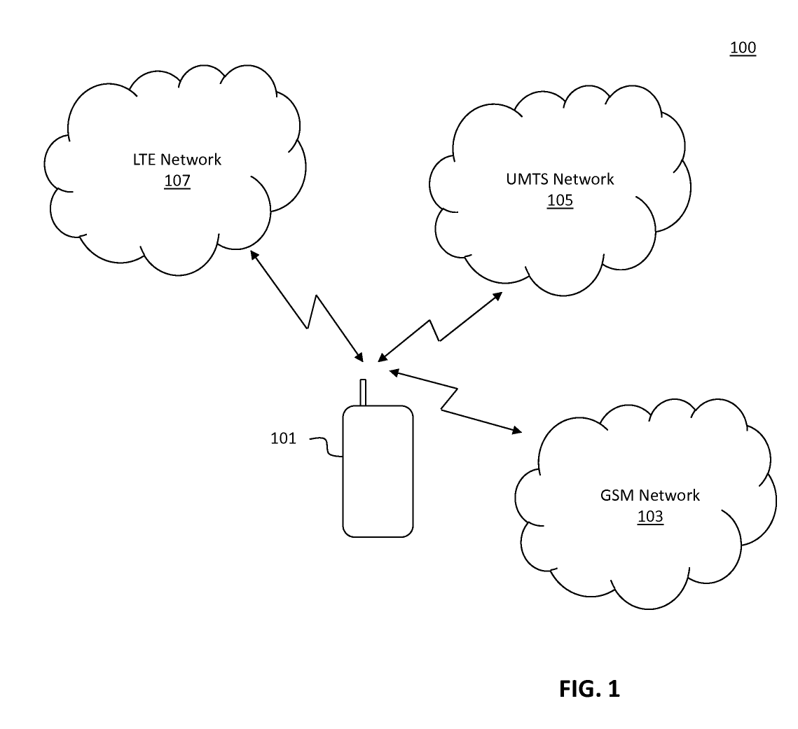

FIG. 1 illustrates a system 100, according to an embodiment of the present disclosure. For example, system 100 illustrates a multi-standby user equipment (UE) 101 that communicates with GSM network 103, UMTS network 105, and/or LTE network 107. In one example, multi-standby UE 101 can be, but is not limited to, a mobile phone, smartphone, personal digital assistant (PDA), etc. Herein, the terms multi-SIM (such as dual-SIM, triple-SIM, etc.) and multi-standby (such as dual-standby, triple-standby, etc.) may be used interchangeably and refer to a wireless device that is capable of simultaneously monitoring paging messages of two independent networks with a single radio resource. For example, a multi-SIM UE may have two or more SIM cards that provide corresponding two or more UE IDs to corresponding two or more network(s). Also, although GSM, UMTS, and LTE networks are shown in FIG. 1, it is understood that other communication networks are within the knowledge of one skilled in the art.

According to one example, GSM network 103 is configured to provide data and/or voice services to various GSM capable communication devices using GSM technology. In one example, UMTS network 105 is configured to provide data and/or voice services to various UMTS capable communication devices using UMTS technology. LTE network 107 is configured to provide data and/or voice services to various LTE capable communication devices using LTE technology.

Multiple SIM cards may be inserted in the multi-standby UE 101 when needed. The SIM cards may be coupled or connected with the multi-standby UE 101 using one or more SIM card sockets or connections. The SIM cards can be used to connect UE 101 to two or more independent network operators and/or wireless technologies. When two or more of the SIM cards are activated, UE 101 can operate in a multi-standby mode, where a user of UE 101 can be allowed to use multiple numbers, multiple different service plans, and/or network carriers at the same time.

According to one example, UE 101 can be a dual-standby UE with a first Virtual Mobile (VM1) associated with a first SIM card registered with a first network operator that provides a first wireless service, and a second Virtual Mobile (VM2) associated with a second SIM card registered with a second network operator that provides a second wireless service. For example, the first and second services can be associated with first and second radio access technologies (e.g. 2G and 3G) Although the discussion in the disclosure is for a dual-standby UE 101, it is understood that multi-standby devices are logical extensions and are within the knowledge of one skilled in the art. Further, although described in terms of multiple network operators, the disclosure also applies to a single operator that provides multiple wireless services (e.g. 2G and 3G), that can have paging collisions.

UE 101 can operate in the multi-standby mode using a single radio resource. UE 101 can include a single radio resource unit that provides physical and radio frequency functionalities to support desired services on UE 101. In other words, the two SIM cards and their virtual modems share the use of the single radio resource. One of these functionality can include using radio resources provided by the radio resource unit to monitor paging events and perform normal idle mode activities: such as cell selection/reselection, when the UE 101 is in an idle state. Each of the independent network operators and/or wireless technologies includes a paging channel that is used by the network operator to page UE 101. For example, when a call is destined for UE 101, the corresponding network operator pages UE 101 using a paging message on the network's paging channel (i.e. predetermined frequency bandwidth). The paging messages are sent on known time intervals on the paging channel. The cycle of the paging messages is a parameter defined by the network operator and/or the wireless technology. When UE 101 is in idle mode, it will check the paging channel at the cycles predetermined by the network operator and/or the wireless technology to determine whether any paging message is being sent for it. Accordingly, in a multi-SIM device, if multiple networks are active, then the UE 101 will continuously check multiple paging channels for paging messages.

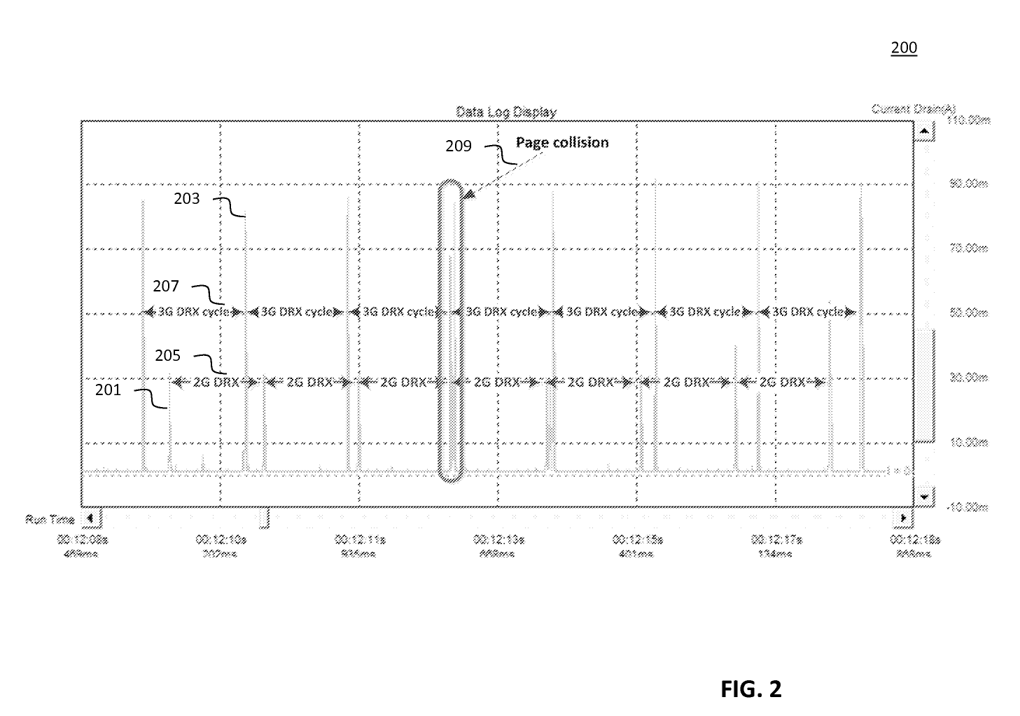

According to one example, dual-standby UE 101 is capable of monitoring the paging channel for VM1 and VM2. The paging channels of VM1 and VM2 can have the same or different cycles for paging messages. A collision is said to occur when the paging cycles require the UE 101 to check the paging channels of VM1 and VM2 at the same time instant (or at times relatively close to each other.) For example, FIG. 2 illustrates exemplary paging cycle for a dual-standby UE 101 operating with VM1 on a GSM network 103 (e.g., 2G) and VM2 operating on a UMTS network 105 (e.g., 3G). The instances 201 represent the instances in time that UE 101 has to monitor the paging channel of VM1 and instances 203 represent the instances where UE 101 has to monitor the paging channel of VM2. Cycles 205 and 207 are paging cycles of VM1 and VM2, respectively, where a cycle is a time period between adjacent monitoring instances for a paging channel.

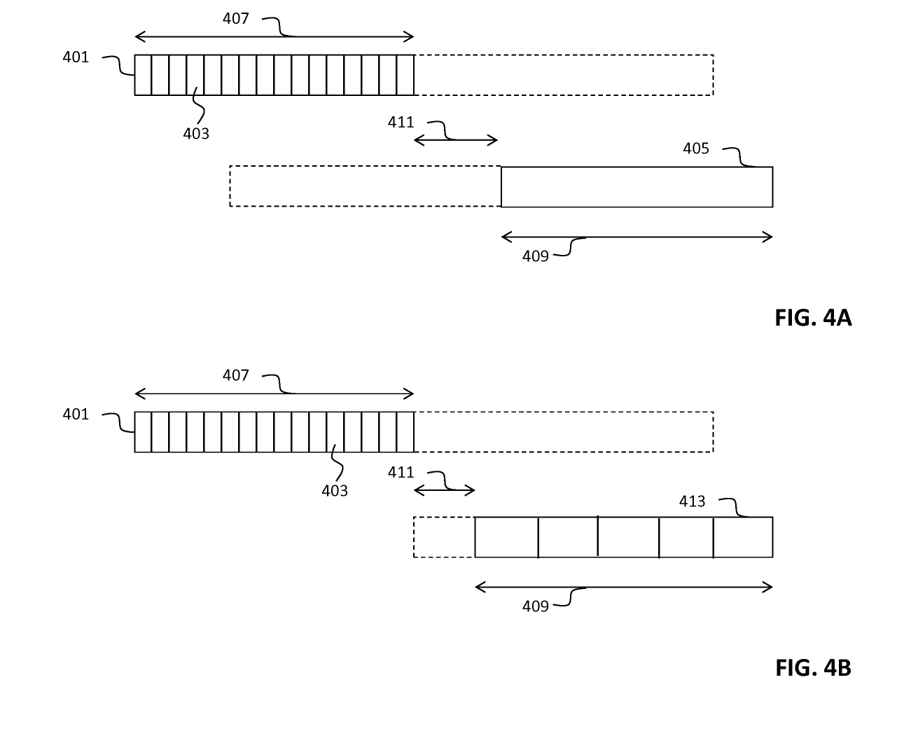

As illustrated in example FIG. 2, the paging cycles for VM1 and VM2 are different, and therefore a collision occurs at page collision 209 when UE 101 has to monitor paging channels of VM1 and VM2 at substantially the same time or within a threshold time period. However, since UE 101 has a single radio resource unit, UE 101 can only monitor one channel at time instance 209, and therefore UE 101 can miss a paging messaging in the channel that was not monitored, A paging collision can occur when a difference between a first time instant to monitor the first paging channel and a second time instant to monitor the second paging channel is less than a predetermined time threshold. This threshold can depend on different parameters, such as how long it takes to monitor paging channels for different network operators and/or communication technologies, how long it takes to switch hardware from monitoring one network operator paging channel and/or communication technology to another, etc. As discussed in detail with respect to FIGS. 4-12, several methods provided herein to improve the performance of UE 101, so as to reduce the page collision probability, and to improve the standby battery performance of UE 101.

As illustrated in FIG. 2, the collision between paging channels of VM1 and VM2 occurs when while UE 101 is monitoring the paging channel of, for example, VM1, and UE 101 receives a request to monitor paging channel of VM2. In this case, although the request for monitoring paging channels does not happen exactly at the same time, nevertheless the collision occurs because UE 101 is busy monitoring one channel when the time for monitoring the second channel arrives, and there must be some transition time allocated to switch between paging channels. Also, it is noted that since the cycle of paging channels is fixed, according to one example, UE 101 can predict the time instances when the collisions will occur based on the cycle of paging channels of VM1 and VM2 and the initial time difference between the two.

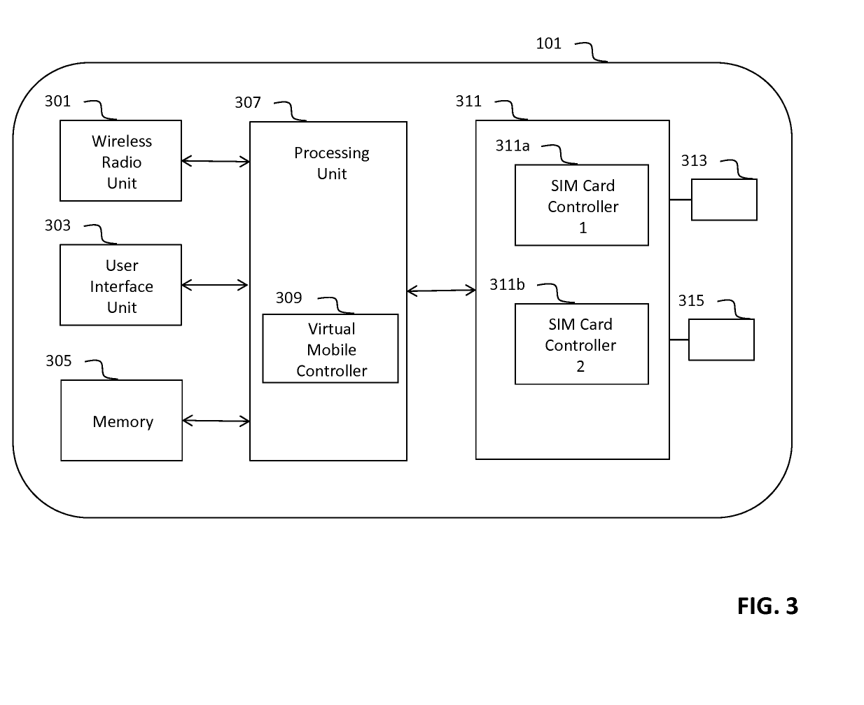

FIG. 3 illustrates a device 101, according to an embodiment of the present disclosure. For example, the device illustrated in FIG. 3 can be implemented as dual-standby UE 101 of FIG. 1. In one example, UE 101 can include, but is not limited to, wireless radio 301, user interface unit 303, memory 305, processing unit 307, SIM card controllers 311, and SIM cards 313 and 315, at least some of which can be executed utilizing one or more processors.

According to one example, wireless radio 301 can be configured to communicate radio frequency signals with various communication networks such as, for example, GSM network 103, UMTS network, 105, and/or LTE network 107. UE 101 uses wireless radio 301 to monitor paging channels associated with independent network operators and/or wireless technologies VM1 and VM2, where, the single wireless radio 301 is shared between SIM cards 313 and 315 for monitoring the paging channels. The wireless radio 301 includes both transmit and receive and therefore can be further described as a transceiver.

According to one example, user interface unit 303 can be configured to enable a user to interact with the dual-standby UE 101. For example user interface unit 303 can be configured to present a user of UE 101 with information on SIM cards 313 and 315 and to allow the user to enter a preferred SIM card selection and/or a desired application selection that may trigger the selection of a particular SIM card. According to one embodiment, memory 305 can be configured to store information such as executable instructions and/or data that can be used by processing unit 307 and/or other device components. For example, memory 305 can be configured to store information such as SIM card identification information of SIM cards 313 and 315, information regarding network operators and/or wireless technologies associated with the SIM cards, information associated with user interface unit 303, information regarding wireless radio 301, and information instruction regarding the selection or activation of a particular SIM card for paging or operational use.

According to one example, processing unit 307 can be configured to manage and/or control operations of device components, including wireless radio 301, user interface 303, memory 305, and/or SIM card controllers 311. In one embodiment, processing unit 307 can be configured to coordinate and/or control the operations of SIM card controllers 311 in response to a SIM card selection. Additionally, processor 307 can be configured to run specific applications based on a application selection from a user of UE 101 that may trigger the selection of a particular SIM card.

According to one embodiment, SIM card controllers 311 can be configured to provide an interface to/from multiple SIM cards, such as SIM cards 313 and 315. For example, UE 101 can include multiple SIM card sockets (not shown) that each provide an electrical and mechanical interface to a respective SIM card, where each SIM card controller 311 can manage the SIM card connected to its corresponding socket. For example, SIM card controllers 311 can be configured activate/deactivate a particular SIM card according to instructions from processor 307, and further download/retrieve information to/from the respective SIM cards when triggered by the processor 307. SIM card controllers 311a and 311b can include software, hardware, or a combination thereof.

According to one example, SIM cards 313 and 315 can be configured to store subscriber personal identification information, such as, operator network, phone number, activated services, billing, credit information, etc. SIM cards 313 and 315 can also be configured to store a user's identity for gaining access to the network and receiving calls, and user's personal information, such as, phone directory and received messages. SIM cards 313 and 315 can be implemented as a small printed circuit board that can be inserted/removed from the UE using the sockets mentioned herein.

In on embodiment, processing unit 307 can include a virtual mobile controller (VMC). VMC 307 that can be a software module, a hardware module, or a combination thereof, having corresponding instructions for causing the processor 307 to operate as described herein. According to this example, VMC 307 can be configured to coordinate and/or control the access of SIM cards 313 and 315 to wireless radio unit 301. Stated another way, VMC 309 can be configured to perform a procedural conflict check and/or a radio resource conflict check to determine whether there are any conflicts between SIM cards to access VMs. According to one example, VMC 309 is configured to arbitrate the conflicts and provide resolutions if conflicts are detected. For example, VMC 309 is configured to perform one or more of several methods discussed in association with FIGS. 4-12, so as to reduce the probability of paging collision, and further to improve the standby battery performance of UE 101.

According to one embodiment, VMC 309 is configured to predict any conflicts that may occur between SIM cards 313 and 315 when accessing the respective paging channels of VM1 and VM2, using a single radio resource. Stated another way, VMC 309 is configured to determine whether a collision will occur between the paging channels and arbitrate the conflict. As an example of paging channel collision detection, assume that UE 101 uses SIM cards 313 and 315 for connection with VM1 and VM2, respectively. At time t₁, SIM card controller 311a of UE 101, at an idle state, uses VMC 309 to access wireless radio unit 301 to monitor the paging channel of VM1. This request is based on the paging cycle of VM1. VMC 309 can determine whether wireless radio unit 301 is busy serving the other SIM card or not. If VMC 309 determines that radio resource is available, VMC 309 can designate the available radio resource to SIM card controller 311a and SIM card 313 to monitor the paging channel of VM1. At time t₂, and before UE 101 finishes monitoring the paging channel of VM1, SIM card controller 311b requests access to wireless radio unit 301 through VMC 309. This request is based on the paging cycle of VM2. At this point, VMC 309 determines that there is no radio resource available because VM1 is still monitoring its respective paging channel, resulting in a collision between paging channels of VM1 and VM2. VMC 309 can perform one or more of methods discussed in association with FIGS. 4-12, to reduce the probability paging channel collision, so as to improve the performance of UE 101. According to one example, when VMC 309 detects the first collision, VMC 309 can determine when the next collisions will occur based on the paging cycles of VM1 and VM2, and also the time difference between the respective cycles. Additionally or alternatively, VMC 309 can predict the first and consecutive collisions based on the paging cycles and time difference between then.

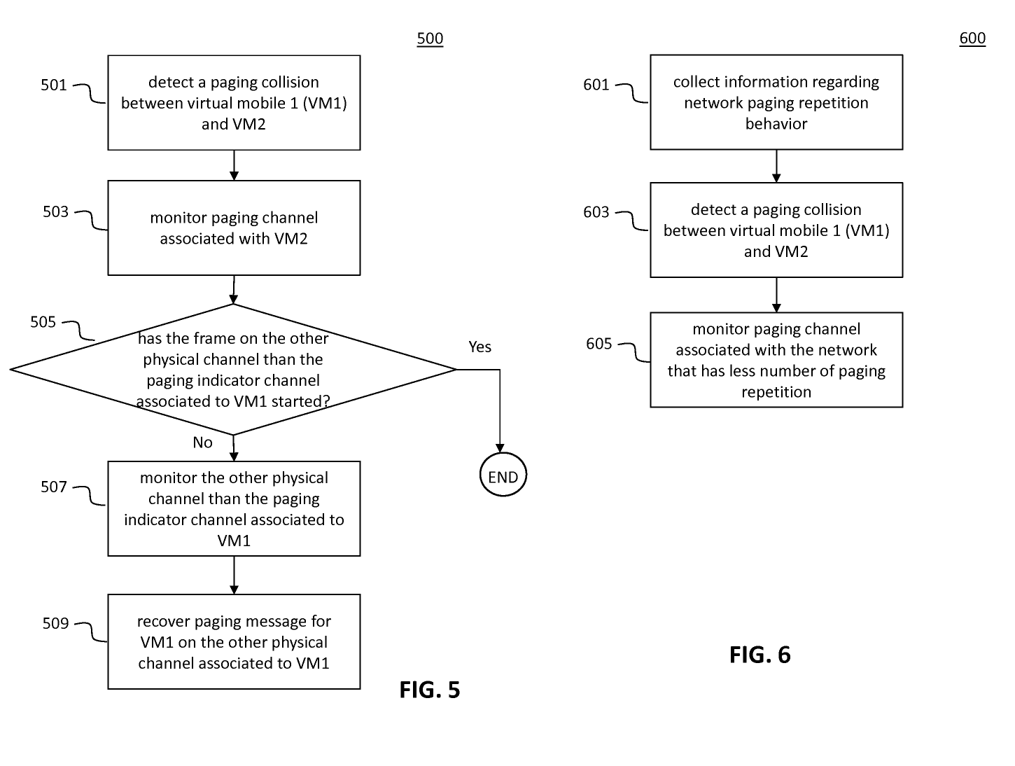

FIGS. 4A, 4B, and 5 illustrate an exemplary method that can be performed by, for example, VMC 309 to reduce probability of collision between paging channels. FIGS. 4A and 4B illustrate timing relationships between two physical channels of a 3G/UMTS system, namely the Paging Indicator Channel (PICH) 401 and the Secondary Common Control Physical Channel (SCCPCH) 405. In 3G/UMTS, there are two levels of page monitoring for UE 101, Initially, PICH 401 on each paging monitoring cycle informs the UE 101 whether a specific page message might exist for UE 101. According to one example, a paging indicator, such as, binary bit 403 in PICH 401 indicates to UE 101 whether a specific page message might exist for UE 101. According to this example, if binary bit 403 is 0, UE 101 can determine that no paging message exists for UE 101 in this paging cycle. However, if binary bit 403 is 1, it indicates that UE 101 might have a message and UE 101 has to check another physical channel to determine whether a paging message exists and if it exist, what the message is. If binary bit 403 is 1, UE 101 has to check the SCCPCH 405 to be certain whether a page message exists and that it is intended for UE 101 after reading the PCH message on SCCPCH.

Referring to FIG. 4A, PICH frame has a duration of 407, SCCPCH frame has a duration of 409, and a delay 411 exists between these two frames. Delay 411 enables UE 411 to detect the paging indicator on PICH 401 and set up, for example, its wireless radio unit 301 to SCCPCH 409 to receive the paging message (Paging Channel (PCH) message). For example, the radio 301 may have to be tuned to a different channel. According to one example, in 3rd Generation Partnership Project (3GPP) standard technical specification 3GPP TS 25.211, the durations 407 and 409 are 10 ms and delay 411 is 2 ms. However, delay 411 can also be a function of where UE 101 monitors its paging channel in PICH frame. Other delays could be used, and it is understood that these durations and delay are within the knowledge of one skilled in the art familiar with these standards. Further, the 3rd Generation Partnership Project (3GPP) standard is incorporated herein by reference.

FIG. 4B illustrate a similar configuration as FIG. 4A that is used in HSPA+, or Evolved High-Speed Packet Access. HSPA+ enhances the widely used WCDMA (UMTS) based 3G networks with higher speeds for the end user that are comparable to the newer LTE networks. Similar to FIG. 4A, FIG. 4B illustrates two levels of page monitoring for UE 101, initially, Paging Indicator Channel (PICH) 401 that includes a paging indicator, such as, binary bit 403, and High Speed-Shared Control Channel (HS-SCCH) 413, which includes one or more sub-frames that provides the paging message assuming one exists for the UE.

FIG. 5 is a flowchart illustrating a method, in accordance with an embodiment of the present disclosure. For example, method 500 can be performed by UE 101. It is to be appreciated not all steps may be needed to perform disclosure provided herein. Further, some of the steps may be performed simultaneously, or in a different order than that shown in FIG. 5, as will be understood by those skilled in the art. Reference is made to UE 101 in FIG. 3 merely for convenience of discussion. Other systems may be used to perform the method as will be understood by those skilled in the art. For convenience, the PICH 401 can be thought of as the paging indicator channel, and the SCCPCH 409 (or HS-SCCH) can be thought of as the paging message, since the UE most go the second paging channel to actually receive the message.

According to this example, dual-standby UE 101 includes a first SIM card 313 for connection to a first network operator using VM1, where VM1 is associated with 3G/UMTS systems. UE 101 includes a second SIM card 315 for connection to a second network operator using VM2. According to one example, VM2 can be associated with 2G/GSM systems, although other network operators can be used for VM2. Unlike in 3G/UMTS systems, in 2G/GSM system the paging monitoring is a one-step monitoring. By checking the paging channel in 2G/GSM, UE 101 can determine whether a paging message exists and can detect the information in the message in on step. In one example, the paging message in 2G/GSM can let UE 101 know that it has a voice call and also a channel that UE 101 can switch to in order to take the call.

According to this example, in step 501, UE 101, for example using VCM 309, determines that a paging collision will occur between VM1 and VM2, where the collision occurs between PICH 401 of VM1 and the paging channel of VM2. Since VM1 is associated with 3G/UMTS systems, UE 101 will have a second opportunity to monitor any paging message on a second physical channel, such as SCCPCH 405 and/or HS-SCCH 413 (herein may be referred to as “paging message channel”). Therefore, in step 503, VCM 309 decides to monitor the paging channel that is associated with VM2. After UE 101 monitors the paging channel associated with VM2, in step 505, UE 101, for example using VCM 309, determines whether a data frame on the paging message channel, such as SCCPCH 405 and/or HS-SCCH 413, associated with VM1 has already started. In one example, UE 101, knowing the time periods for each frame and delays between them for VM1 can make the determination in step 505. If the other physical channel of VM1 has already started, UE 101 concludes that a collision has occurred and cannot be arbitrated and therefore, a paging message for the first SIM card is not recoverable.

However, if VM1 detects that the paging message channel of VM1 has not started, UE 101 can take advantage of the time delay between the paging indicator channel and the paging message channel of VM1 and can monitor the paging message channel (such as SCCPCH 405 and/or HS-SCCH 413) to monitor for the paging message. The monitoring of the paging message channel of VM1 occurs in the same paging cycle as that the monitoring of the paging indicator channel of VM1 that was skipped (because of collision with paging channel of VM2.)

In step 509, UE 101 can recover the paging message for VM1, if any existed for UE 101. Therefore, according to this exemplary embodiment, UE 101 takes advantage of two stage page monitoring in 3G/UMTS systems and the time delay between the paging indicator channel (PICH) and the paging message channel. Accordingly, the page collision probability is reduced which improves the performance of UE 101, and both the paging for VM1 and VM2 are able to be successfully monitored.

It is noted in the above description of FIG. 5, and herein, that VMC 309 can monitor the respective paging channels at the proscribed times using the wireless radio, or VMC 309 can control/provide access by controllers 311 associated the respective SIM 313/315 to the wireless radio to perform the paging monitoring and/or message recovery.

FIG. 6 is a flowchart illustrating a method, in accordance with another embodiment of the present disclosure. For example, method 600 can be performed by UE 101. It is to be appreciated not all steps may be needed to perform disclosure provided herein. Further, some of the steps may be performed simultaneously, or in a different order than that shown in FIG. 6, as will be understood by those skilled in the art. Reference is made to UE 101 in FIG. 3 merely for convenience of discussion. Other systems may be used to perform the method as will be understood by those skilled in the art.

When paging a user equipment, network providers send multiple copies of a paging message to the UE. Because of the wireless nature of the connection between UE and networks, there is a possibility that the UE cannot receive a paging message. Therefore, network providers repeat the paging messages. According to one embodiment, UE 101 can take advantage of this repetition to decrease the probability of paging collision.

According to this exemplary embodiment, in step 601 UE 101 collects information regarding the networks paging repetition behavior. For example, UE 101 can detect that VM1 repeats a paging message for n₁ times and VM2 repeats a paging message n₂ times. The number of repetitions can depend on the network provider, the corresponding radio access technology (RAT), etc. According to one example, UE can collect network configuration information, including paging message repetition, from over the air messages it receive or such information can be pushed to UE 101 by the network operator using different means. In one example, UE 101 can monitor paging messages for other UEs and use the information to determine the paging repetition configuration of the network. According to this example, UE 101 can count the number of paging messages that have the same user ID to determine network paging repetition information.

In step 603, UE 101 detects a paging collision between paging channels of VM1 and VM2. In step 605, UE 101 uses the paging repetition information for VM1 and VM2 to monitor paging channel of the network that has less number of paging repetition. Accordingly, the page collision probability can be reduced to improve the performance of UE 101. In other words, priority access to the wireless radio is given to the VM that has the lower paging repetition, contemplating that the higher repetition VM may be still be available afterward.

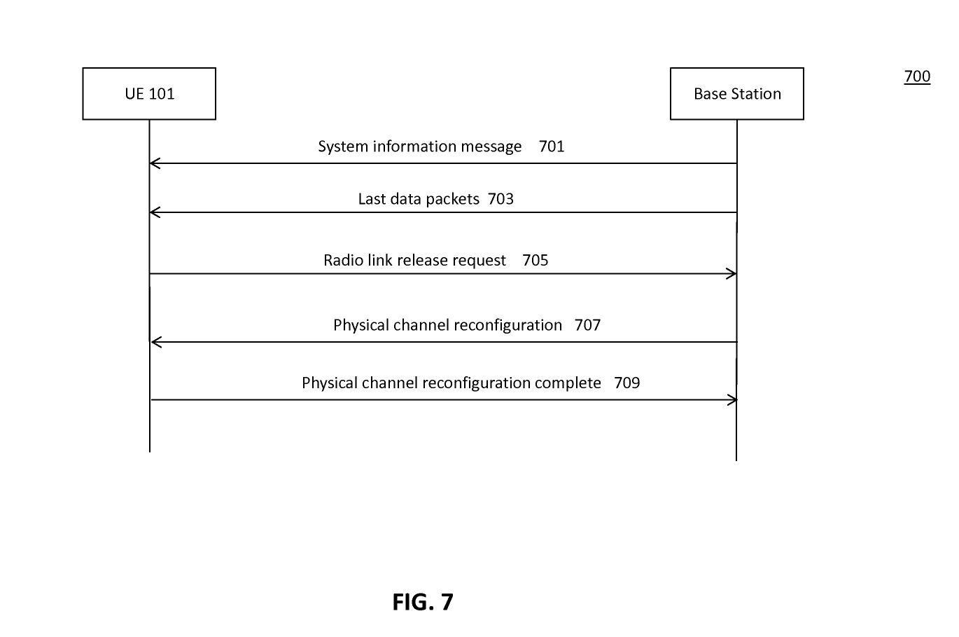

FIG. 7 illustrates a timing diagram, in accordance with a conventional method that is provided for comparison purposes. According to this example, dual-standby UE 101 includes a first SIM card 313 for connection to a first network operator VM1, where VM1 is associated with 3G/UMTS systems. UE 101 includes a second SIM card 315 for connection to a second network operator VM2. According to one example, VM2 can be associated with 2G/GSM systems. Although other network operators can be used for VM2.

According to this example, UE 101 receives a system information message 701 from a base station (BS) associated with VM1, which can include different information, such as an identifier of cell area associated with BS, information about BS, information about radio network controller, and the like. UE 101 further receives last data packets 703 from base station and therefore the connection with VM1 is completed. UE 101 sends a radio link release request 705 to the base station. In one example, where 3rd Generation Partnership Project (3GPP) standards are used, message 705 includes a signallingConnectionReleaseIndication message that includes the cause ueRequestedPSDataSessionEnd. In response, the base stations transmit a physical channel reconfiguration message 707. In a 3GPP system, message 707 can include physicalChannelReconfiguration message including rrcState: CELL_PCH with DRX5. UE 101 sends a physical channel reconfiguration complete message 709 to the base station to indicate the completion of the reconfiguration procedure. In a 3GPP system, message 709 includes physicalChannelReconfigurationComplete. Herein, it is noted that messages associated with a specific standard are shown in italic for identification purposes. It is understood that these messages are within the knowledge of one skilled in the art familiar with these standards. Further, the 3rd Generation Partnership Project (3GPP) standard is incorporated herein by reference.

According to this conventional example, after UE 101 requests for radio link release, base station requests UE 101 to be in radio resource control state (rrcState). During rrcState, UE 101 monitors the paging channel of VM1 with a higher frequency than normal. When UE 101 is requested to monitor the paging channel of VM1 with a higher frequency, the probability of paging collision between paging channels of VM1 and VM2 is increased.

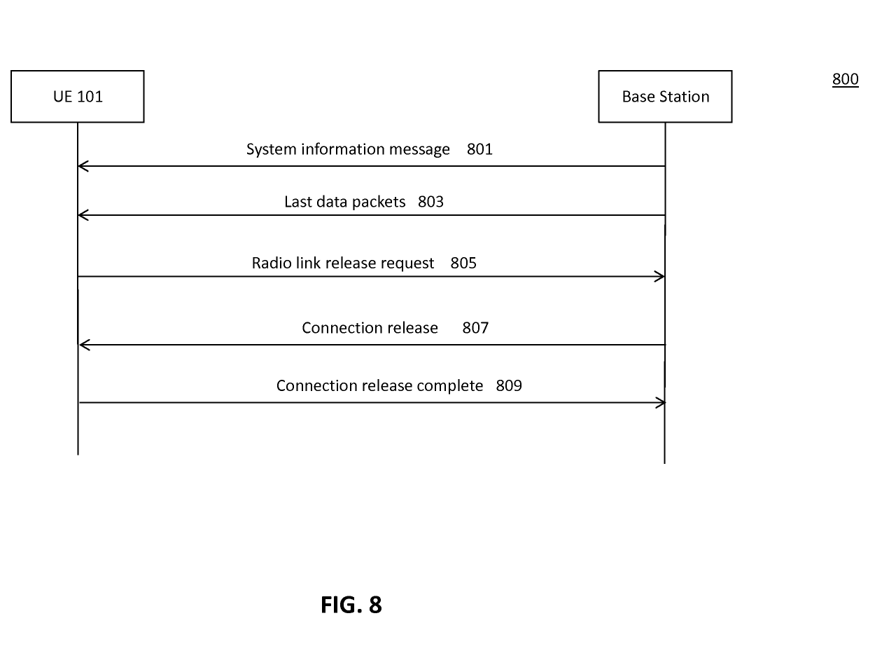

FIG. 8 illustrates a timing diagram, in accordance with an embodiment of the present disclosure. According to this example, dual-standby UE 101 includes a first SIM card 313 for connection to a first network operator VM1, where VM1 is associated with 3G/UMTS systems. UE 101 includes a second SIM card 315 for connection to a second network operator VM2. According to one example, VM2 can be associated with 2G/GSM systems. Although other network operators can be used for VM2.

According to this example, UE 101 receives a system information message 801 from a base station (BS) associated with VM1, which can include different information, such as an identifier of cell area associated with BS, information about BS, information about radio network controller, and the like. UE 101 further receives last data packets 803 from base station and therefore the connection with VM1 is completed. UE 101 sends a radio link release request 805 to the base station. In one example, where 3rd Generation Partnership Project (3GPP) standards are used, message 805 includes a signallingConnectionReleaseIindication message that includes the cause anyOtherCause. In this embodiment, UE 101 uses the cause anyOtherCause instead of the cause ueRequestedPSDataSessionEnd used in the conventional method of FIG. 7.

Using the “any other cause” in message 805, facilitates the network transitioning UE 101 to IDLE mode where the paging monitoring is normal, rather than the high frequency page monitoring (e.g. default) of conventional method of FIG. 7. In one example the high paging monitoring frequency include page monitoring cycles of 320 ms (DRX5—Discontinuous Reception). Additionally or alternatively, the reduced page monitoring frequency include page monitoring cycles of 1.28 s (DRX7). Accordingly, UE 101 by determining its dual-standby nature and requesting from the network, will be put in a state with reduced paging monitoring frequency. Accordingly, the page collision probability can be reduced to improve the performance of UE 101.

Base station will send a connection release 807 in response to message 805. In a 3GPP system, message 807 can include rccConnectionRelease message. After configuration completion, UE 101 send a connection release complete message 809. In a 3GPP system, message 807 can include rccConnectionReleaseComplete message.

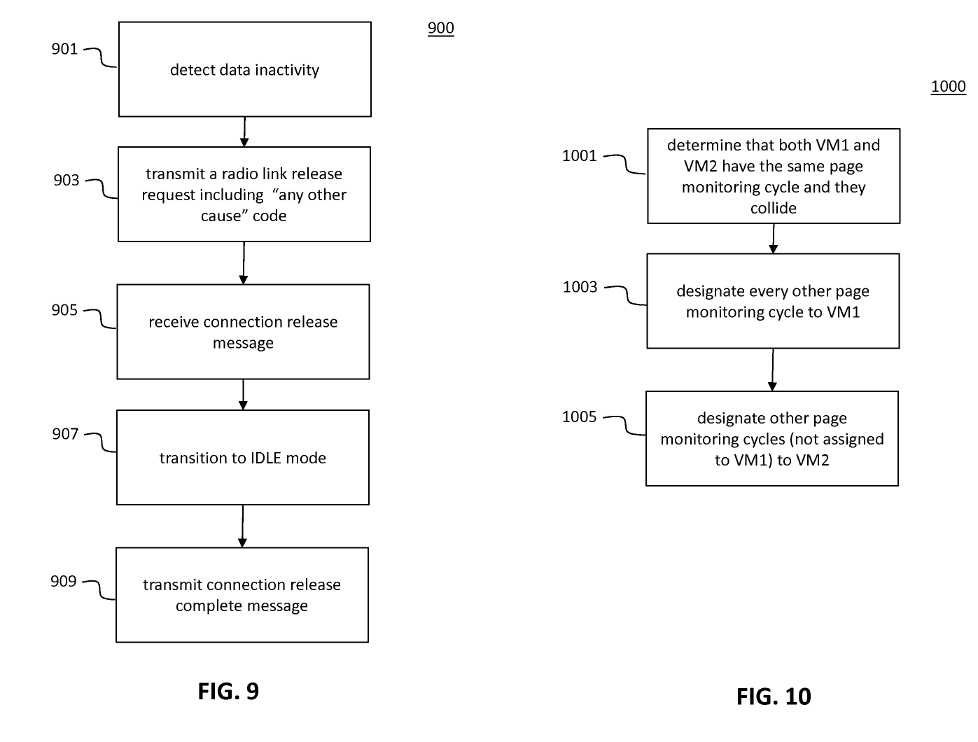

FIG. 9 is a flowchart illustrating a method, in accordance with another embodiment of the present disclosure. For example, method 900 can be performed by UE 101. It is to be appreciated not all steps may be needed to perform disclosure provided herein. Further, some of the steps may be performed simultaneously, or in a different order than that shown in FIG. 9, as will be understood by those skilled in the art. Reference is made to UE 101 in FIG. 3 merely for convenience of discussion. Other systems may be used to perform the method as will be understood by those skilled in the art.

Method of FIG. 9 is discussed with reference to the time diagram of FIG. 8, for illustrative purposes. According to this example, dual-standby UE 101 includes a first SIM card 313 for connection to a first network operator VM1, where VM1 is associated with 3G/UMTS systems. UE 101 includes a second SIM card 315 for connection to a second network operator VM2. According to one example, VM2 can be associated with 2G/GSM systems. Although other network operators can be used for VM2.

In step 901, UE detects a period of inactivity. In one example this period is detected after the last data packets 803 of FIG. 8 are received from a corresponding base-station of VM1. In step 903, UE 101 transmits a radio link release request (such as request 805) that includes the cause “any other cause” to a base station associated with VM1. In step 905, UE 101 receives a connection release message, such as message 807 of FIG. 8 and in step 907, UE 101 transitions to IDLE mode. In step 909, UE 101 sends a connection release complete message, such as message 809, indicating that UE 101 is in IDLE mode. In this example, by sending the radio link release request (such as request 805) that includes the cause “any other cause”, UE 101 requests to be transitioned to a state that has a reduced page monitoring frequency in comparison to what the network provider requests from UE 101.

FIG. 10 is a flowchart illustrating a method, in accordance with another embodiment of the present disclosure. For example, method 1000 can be performed by UE 101. It is to be appreciated not all steps may be needed to perform disclosure provided herein. Further, some of the steps may be performed simultaneously, or in a different order than that shown in FIG. 10, as will be understood by those skilled in the art. Reference is made to UE 101 in FIG. 3 merely for convenience of discussion. Other systems may be used to perform the method as will be understood by those skilled in the art.

In this exemplary embodiment, both VM1 and VM2 that serve UE 101 belong to the same network operator. Therefore, there is a possibility that both VM1 and VM2 have the same page monitoring cycles, where the paging wake-up for both VM1 and VM2 occurs at the same time (there is no time difference between page monitoring cycles.) In this situation there is a % 100 chance of paging collision, or at least a high probability of a paging collision. According to one embodiment, in step 1001, UE 101 determines that both VM1 and VM2 have the same page monitoring cycles and they collide. In one example, UE 101 can make this determination based on information regarding the page monitoring cycle of each VM received during connection initiation to the VMs, or during operation.

When UE 101 determines that both VM1 and VM2 have the same page monitoring cycles and they collide. UE 101 can designate every other page monitoring wake-ups of the cycles to VM1, in step 1003, and can designate the other page monitoring wake-ups of the cycles to VM2, in step 1005. In other words, the UE alternates between VM1 and VM2 for the page monitoring cycles. It is noted that in this situation, VMs do not have to be in the same radio access technology (RAT). For example, method 1000 is applicable if VM1 and VM2 include different RATs but have the same paging periodicity.

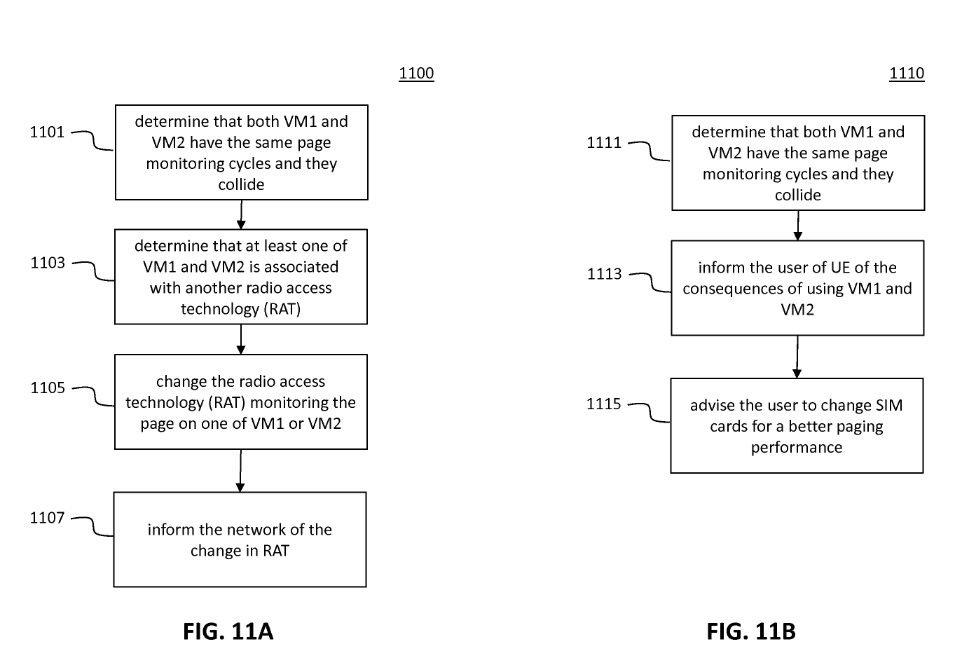

FIG. 11A is a flowchart illustrating a method, in accordance with another embodiment of the present disclosure. For example, method 1110 can be performed by UE 101. It is to be appreciated not all steps may be needed to perform disclosure provided herein. Further, some of the steps may be performed simultaneously, or in a different order than that shown in FIG. 11A, as will be understood by those skilled in the art. Reference is made to UE 101 in FIG. 3 merely for convenience of discussion. Other systems may be used to perform the method as will be understood by those skilled in the art.

For a multi-RAT UE (e.g., a UE supporting GSM, UMTS, and/or LTE technologies), the RAT that the UE is supposed to camp on and monitor the paging channel is determined by the network (for example by cell re-selection parameters in systemInformationBlockType-3 message.) Therefore, it is not expected that the UE will change the camped RAT. Depending on, for example, signal strengths for different RATS, the network can ask UE to choose one RAT over the other.

According this exemplary embodiment, both VM1 and VM2 have the same radio access technology and the same page monitoring cycles that collide. In step 1101, UE 101 can determine that VM1 and VM2 have the same page monitoring cycles and they collide, based on connection initiation or a priori knowledge. In step 1103. UE 101 determines that at least one of VM1 and VM2 support an additional, or secondary, radio technology. As an exemplary and non-limiting embodiment, UE 101 can detect that both VM1 and VM2 are on 3G and have the same page monitoring cycles that collide. Further, UE 101 can detect that, for example, VM1 also supports 2G. In this example, UE 101 can change the radio access technology of VM1 from 3G to 2G in step 1105 so that the paging monitoring cycle of VM1 differ from the paging monitoring cycle of VM2. In step 1107, UE 101 informs the network associated with VM1 that the RAT for VM1 has changed. By informing the network, UE 101 can avoid any consequences, such as losing synchronization with the network. Therefore, by changing the radio access technology of one of VM1 or VM2, the paging reception of VM1 and VM2 is re-distributed to avoid the chance of collision.

FIG. 11B is a flowchart illustrating a method, in accordance with another embodiment of the present disclosure. For example, method 1110 can be performed by UE 101. It is to be appreciated not all steps may be needed to perform disclosure provided herein. Further, some of the steps may be performed simultaneously, or in a different order than that shown in FIG. 11B, as will be understood by those skilled in the art. Reference is made to UE 101 in FIG. 3 merely for convenience of discussion. Other systems may be used to perform the method as will be understood by those skilled in the art.

Method 1110 is another solution to solve the problem that was also solved by method 1100 of FIG. 11A. In step 1111, UE 101 determines that both VM1 and VM2 have the same page monitoring cycles and they collide. In step 1113, UE 101 informs the user of UE of the consequences of using VM1 and VM2. In step 1115, UE 101 advises the user to change SIM cards for a better paging performance. For example, a message may be flashed on the user interface 303.

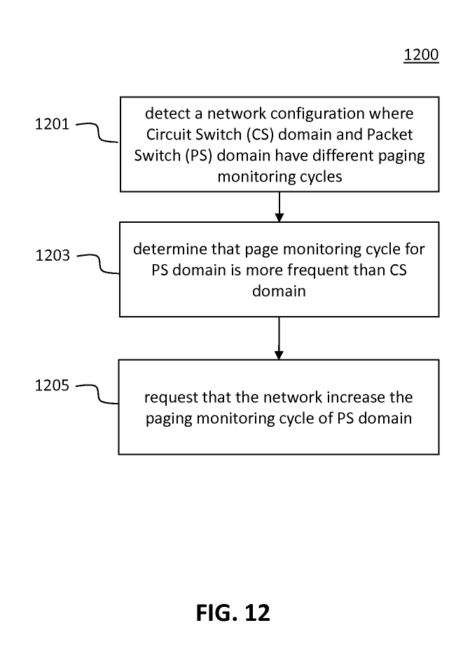

FIG. 12 is a flowchart illustrating, a method, in accordance with another embodiment of the present disclosure. For example, method 1200 can be performed by UE 101. It is to be appreciated not all steps may be needed to perform disclosure provided herein. Further, some of the steps may be performed simultaneously, or in a different order than that shown in FIG. 12, as will be understood by those skilled in the art. Reference is made to UE 101 in FIG. 3 merely for convenience of discussion. Other systems may be used to perform the method as will be understood by those skilled in the art.

According to this example, dual-standby UE 101 includes a first SIM card 313 for connection to a first network operator VM1 and a second SIM card 315 for connection to a second network operator VM2. In one example, at least one of VM1 and VM2 is associated with 3G/UMTS systems. According to the technical specification of 3GPP, for example 3GPP TS 24.008, UE 101 can request that the network increase the paging monitoring period of a given VM. For example, according to 3GPP TS 24.008, UE 101 can use “UE Specific DRX parameter handling” method on Non-Access Stratum (NAS) protocol stack level to request for an increase in its paging monitoring period. These benefits are available if the network operator implements different paging cycle for Circuit Switch (CS—that can be used, for example, for voice) and for Packet Switched (PS—that can be used, for example, for data) domain, where the paging cycles for PS domain is usually more frequent than the CS domain. In 3G/UMTS systems, if the paging cycles are different for CS and PS domains, UE is required to monitor the paging channel using the more frequent cycle, that could result in higher probability of paging collision. According to one example, if the CS domain has a paging cycle period of 1.28 seconds and PS domain has a paging cycle period of 0.640 second, UE is required (for example by 3GPP TS 25.304) to monitor the paging channel using the more frequent cycle with period of 0.640 second. However, it is noted that it is not un-common for commercial network operators to use shorter paging monitoring period for PS domain compared to CS domain.

In this exemplary embodiment, in step 1201, UE 101 can detect that network configuration of, for example, VM1 indicates that CS and PS domains have different paging monitoring cycles. In step 1203, UE 101 can detect that the paging monitoring cycle for PS domain is more frequent than the CS domain. Accordingly, in step 1205, UE 101 requests that VM1 increase the paging monitoring cycle for PS domain. In one example, UE 101 can use “UE Specific DRX parameter handling” method on Non-Access Stratum (NAS) to request the increase in the paging monitoring cycle for the PS domain.

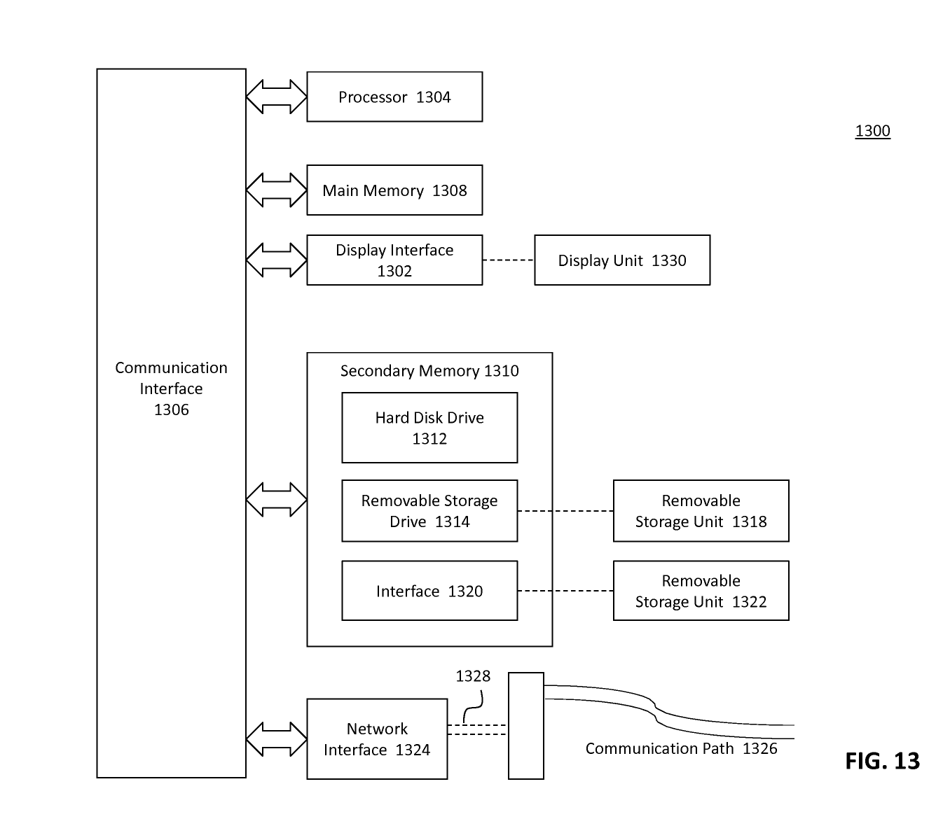

Various aspects of the present disclosure can be implemented by software, firmware, hardware, or a combination thereof. FIG. 13 illustrates an example computer system 1300 in which the present disclosure, or portions thereof, can be implemented as computer-readable code. For example, methods 500, 600, 900, 1000, 1100, 1110, 1200 can be implemented by computer system 1300. Various embodiments of the disclosure are described in terms of this example computer system 1300. After reading this description, it will become apparent to a person skilled in the relevant art how to implement the disclosure using other computer systems and/or computer architectures.

Computer system 1300 includes one or more processors, such as processor 1304. Processor 1304 can be a special purpose or a general purpose processor. Processor 1304 is connected to a communication infrastructure 1306 (for example, a bus or network).

Computer system 1300 also includes a main memory 1308, preferably random access memory (RAM), and may also include a secondary memory 1310. Secondary memory 1310 may include, for example, a hard disk drive 1312, a removable storage drive 1314, and/or a memory stick. Removable storage drive 1314 may comprise a floppy disk drive, a magnetic tape drive, an optical disk drive, a flash memory, or the like. The removable storage drive 1314 reads from and/or writes to a removable storage unit 1318 in a well-known manner. Removable storage unit 1318 may comprise a floppy disk, magnetic tape, optical disk, etc. that is read by and written to by removable storage drive 1314. As will be appreciated by persons skilled in the relevant art(s), removable storage unit 1318 includes a computer usable storage medium having stored therein computer software and/or data.

In alternative implementations, secondary memory 1310 may include other similar means for allowing computer programs or other instructions to be loaded into computer system 1300. Such means may include, for example, a removable storage unit 1322 and an interface 1320. Examples of such means may include a program cartridge and cartridge interface (such as that found in video game devices), a removable memory chip (such as an EPROM, or PROM) and associated socket, and other removable storage units 1322 and interfaces 1320 that allow software and data to be transferred from the removable storage unit 1322 to computer system 1300.

Computer system 1300 may also include a communications interface 1324. Communications interface 1324 allows software and data to be transferred between computer system 1300 and external devices. Communications interface 1324 may include a modem, a network interface (such as an Ethernet card), a communications port, a PCMCIA slot and card, or the like. Software and data transferred via communications interface 1324 are in the form of signals that may be electronic, electromagnetic, optical, or other signals capable of being received by communications interface 1324. These signals are provided to communications interface 1324 via a communications path 1326. Communications path 1326 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 1318, removable storage unit 1322, and a hard disk installed in hard disk drive 1312. Signals carried over communications path 1326 can also embody the logic described herein. Computer program medium and computer usable medium can also refer to memories, such as main memory 1308 and secondary memory 1310, which can be memory semiconductors (e.g. DRAMs, etc.). These computer program products are means for providing software to computer system 1300.

Computer programs (also called computer control logic) are stored in main memory 1308 and/or secondary memory 1310. Computer programs may also be received via communications interface 1324. Such computer programs, when executed, enable computer system 1300 to implement the present disclosure as discussed herein. In particular, the computer programs, when executed, enable processor 1304 to implement the processes of the present disclosure. Accordingly, such computer programs represent controllers of the computer system 1300. Where the disclosure is implemented using software, the software may be stored in a computer program product and loaded into computer system 1300 using removable storage drive 1314, interface 1320, hard drive 1312 or communications interface 1324.

The disclosure is also directed to computer program products comprising software stored on any computer useable medium. Such software, when executed in one or more data processing device, causes a data processing device(s) to operate as described herein. Embodiments of the disclosure employ any computer useable or readable medium, known now or in the future. Examples of computer useable mediums include, but are not limited to, primary storage devices (e.g., any type of random access memory), secondary storage devices (e.g., hard drives, floppy disks, CI) ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

The exemplary embodiments described herein are provided for illustrative purposes, and are not limiting. Other exemplary embodiments are possible, and modifications may be made to the exemplary embodiments within the spirit and scope of the disclosure.

It is to be appreciated that the Detailed Description section, and not the Abstract section, is intended to be used to interpret the claims. The Abstract section may set forth one or more, but not all exemplary embodiments, of the disclosure, and thus, are not intended to limit the disclosure and the appended claims in any way.

The disclosure has been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus the disclosure should not be limited by any of the above-described exemplary embodiments. Further, the claims should be defined only in accordance with their recitations and their equivalents.

What is claimed is:

1. A user equipment (UE), comprising:
a wireless radio;
a first subscriber identification module (SIM) associated with a first network service having a first paging cycle, the first paging cycle having a paging indicator channel and a paging message channel;
a second SIM associated with a second network service having a second paging cycle that includes a paging message channel; and
a controller to arbitrate access to the wireless radio, the controller configured to:
determine when a collision will occur between the paging indicator channel of the first paging cycle and the paging message channel of the second paging cycle;
monitor the paging message channel of the second paging cycle using the wireless radio when the collision occurs, and recover any message on the second paging cycle; and
monitor the paging message channel of the first paging cycle using the wireless radio after the second paging cycle is complete or a message is recovered during the second paging cycle.

2. The UE of claim 1, wherein the first network service and the second network service operate according to respective first and second radio access technologies (RATs) that are different from each other.

3. The UE of claim 2, wherein:
the first RAT is associated with a Universal Mobile Telecommunications System (UMTS) network, and the second RAT is associated with a network that is different from the UMTS network;
the paging indicator channel is defined by a standard associated with the UMTS network, and
the paging message channel of the first paging cycle is one of Secondary Common Control Physical Channel (SCCPCH) or High Speed-Shared Control Channel (HS-SCCH) that are defined by the standard associated with the UMTS network.

3. The UE of claim 1, wherein the paging collision occurs when a difference between a first time instant to monitor the paging indicator channel of the first paging cycle and a second time instant to monitor the paging message channel of the second paging cycle is less than a threshold.

4. The UE of claim 1, wherein after the second paging cycle is complete, the controller is further configured to:
determine if a data frame of the paging message channel of the first paging cycle has started before the second paging cycle is complete;
abort the data frame when the data frame has started before the second paging cycle is complete; and
recover any message on the paging message channel of the first paging cycle when the data frame is available.

5. The UE of claim 1, wherein the controller is further configured to:
monitor the paging indicator channel of the first paging cycle using the wireless radio when a collision does not occur;
recover a paging message from the paging message channel of the first paging cycle using the wireless radio when the paging indictor channel provides an indication of the paging message; and
monitor the paging message channel of the second paging cycle after the first paging cycle is complete.

6. The UE of claim 5, wherein the controller is further configured to:
tune the wireless radio from a frequency of the paging indictor channel to a frequency of the paging message channel when the paging indicator channel provides the indication of the paging message on the paging message channel.

7. The UE of claim 1, wherein the collision is one of a plurality of collisions between the first paging cycle and the second paging cycle, the controller further configured to provide priority access to the wireless radio to the second SIM during time instances of the plurality of collisions.

8. The UE of claim 7, wherein the controller is further configured to tune the wireless radio to a frequency of the paging message channel of the second paging cycle when priority is given to the second SIM.

9. A user equipment (UE), comprising:
a wireless radio;
a first subscriber identification module (SIM) associated with a first network service having a first paging channel with a first paging repetition rate;
a second SIM associated with a second network service having a second paging channel with a second repetition rate; and
a controller to arbitrate access to the wireless radio, the controller configured to:
compare the first paging repetition rate to the second paging repetition rate and determine which is lower; and
monitor a first one of the first and second paging channels that has the lower paging repetition rate when a collision occurs between the first and second paging channels.

10. The UE of claim 9, wherein the controller is further configured to:
monitor a second one of the first and second paging channels after monitoring the first one of the first and second paging channels.

11. The UE of claim 9, wherein the first network service and the second network service operate according to respective first and second radio access technologies (RATs) that are different from each other.

12. The UP of claim 11, wherein:
the first RAT is associated with a Universal Mobile Telecommunications System (UMTS) network, and the second RAT is associated with a network that is different from the UMTS network.

13. The UE of claim 9, wherein the controller is further configured to determine the first and second paging repetition rates by receiving respective control messages having the respective repetition rates from respective network entities associated with the respective first and second network services.

14. The UE of claim 9, wherein the controller is further configured to determine the first and second paging repetition rates by monitoring paging channels of one or more other UEs having the same first and second network services to determine the first and second paging repetition rates.

15. A user equipment (UE), comprising:
a wireless radio;
a first subscriber identification module (SIM) associated with a first network service having a first paging channel with a default paging repetition rate;
a second SIM associated with a second network service having a second paging channel; and
a controller to arbitrate access to the wireless radio, the controller configured to:
detect data inactivity on the first network service; and
transmit a radio link release request using the wireless radio to a base station associated with the first network service, wherein the radio link release request includes a message requesting for a paging repetition rate that is lower than the default paging repetition rate.

16. The UE of claim 15, wherein the first network service operates according to a 3^{rd} Generation Partnership Project (3GPP) standard, and wherein the message is an anyOtherCause message defined by the 3GPP standard.

17. The UE of claim 16, wherein the anyOtherCause message causes a base station associated with the first network service to assign the paging repetition rate that is lower than the default paging repetition rate to the UE.

18. The UE of claim 16, wherein the default paging repetition rate is associated with a ueRequestedPSDataSessionEnd message defined by the 3GPP standard.

19. The UE of claim 15, wherein the first network service and the second network service operate according to respective first and second radio access technologies (RATs) that are different from each other.

20. The UE of claim 19, wherein:
the first RAT is associated with a Universal Mobile Telecommunications System (UMTS) network, and the second RAT is associated with a network that is different from UMTS.
